(19) United States
(12) Patent Application Publication
(10) Pub. No.: US 2023/0372974 A1
(43) Pub. Date: Nov. 23, 2023

(54) POWDER SIEVING APPARATUS FOR POWDER COATING SYSTEM

(71) Applicant: AMAL BHUPENDRA SHAH, (W) MUMBAI (IN)

(72) Inventor: AMAL BHUPENDRA SHAH, (W) MUMBAI (IN)

(21) Appl. No.: 18/198,158

(22) Filed: May 16, 2023

(30) Foreign Application Priority Data
May 17, 2022 (IN) 202221028391

(51) Int. Cl. B07B 1/52; B07B 1/18; B05B 15/40

(52) U.S. Cl. CPC B07B 1/524; B07B 1/18; B05B 15/40

(57) ABSTRACT

This invention relates to a powder sieving apparatus for a powder coating system and a powder suction system thereof. the present invention provides a powder sieving apparatus for a powder coating system having a powder spray gun, a powder suction pump assembly, and a powder container/hopper. As per the present invention, the said sieving apparatus comprises a housing having at least one outlet connected to a suction side of the powder suction pump and an inlet connected to a suction pipe dipped in the powder container, a cylindrical sieve having a sieve mesh adapted within the housing dividing the housing into an inner and outer compartments, a brush holder rotatably and/or oscillatingly adapted in the inner compartment of the housing for cleaning the cylindrical sieve. The present siveing apparatus provides freshly sieved powder free of large impurities and the powder particles and presented to the charging device such as a powder spray gun and the particles are thus charged better resulting in substantially and better transfer efficiency and this results in lower powder consumption.

### CROSS-REFERENCE TO RELATED APPLICATION

This application claims priority under 35 U.S.C. § 119 to India Patent Application No. 202221028391, filed May 17, 2022, the disclosure of which is incorporated herein by reference.

### FIELD OF THE INVENTION

This invention relates to a powder sieving apparatus for a powder coating system and a powder suction system thereof.

### BACKGROUND OF THE INVENTION

Generally, a powder paint coating system comprises a container/hopper for fluidizing powder, a powder suction pump for the suction of the powder and a powder spray gun for charging and spraying the powder for providing a protective coating over a workpiece to be coated. These components are mounted on a trolley and connected by hoses and cables with all the necessary regulators and fittings to complete the powder paint coating system.

The conventional powder suction pump assembly (50) of the powder coating system is shown in FIG. 1A. As shown in FIG. 1A, the conventional powder suction pump (10) comprises two air inlets namely primary/conveying/suction air inlet (12) (herein after referred as ‘primary air inlet’) and secondary/carrier/dosing air inlet (14) (herein after referred as ‘secondary air inlet’). A primary air inlet (12) is an inlet for compressed air which creates suction and is responsible for the quantity of powder output from the pump (10). The suction of powder takes place when high pressure air is introduced into the powder suction venturi pump via the primary air inlet (12) through a nozzle having of small orifice (not shown). As the volume of high-pressure air being introduced is very low, this air volume is insufficient to carry the sucked powder smoothly through the hose and through the gun and hence the spray pattern with such a small volume of suction air is not uniform but lumpy and streaky. Therefore, an additional secondary/carrier air of adjustable volume is added in the pump (generally in the stream of flowing powder) from the secondary air inlet (14) to aid the smooth movement as well as the speed of powder through the hose and gun and thereby achieve the uniform spray output.

Generally, fresh powder is packed in boxes and transported over long distances by the powder manufacturer to the user. During transportation it is observed that the powder gets agglomerated in the box itself. Thus, the powder needs to be sieved prior to use. As per the standard conventional methods used in the powder coating industry, powder is passed through a sieving device operating on a vibratory or gyratory or rotary motion—using known means such as pneumatic, electric, mechanical, or ultrasonic methods. The sieved powder is then transported to the hopper or container of the powder spray gun.

The powder suction pump sucks and transports the powder from the hopper/container to the gun tip and out of the spray gun. Powder is sprayed from the tip of the gun of the powder spray equipment. The Powder spray gun electrostatically charges and sprays the powder onto the workpiece which needs to be powder coated. The charged powder adheres to the work-piece due to electrostatic charge. The over sprayed powder falls down which is then collected in a chamber and send to recovery system such as cyclone or filter recovery system connected to the powder spray booth. The ratio of the amount of powder adhering to the workpiece to the amount of powder sprayed out of the powder spray equipment is called transfer efficiency. Further, it is also observed that recovered powder is collected in bins and later transported to the sieving machine and from sieve machine to the powder hopper for collection, storage and for feeding to the spray gun, using pumps or often by manual transfer. This transport action leads to agglomeration of powder. Moisture and contaminants also may creep into the powder after receipt and during usage.

Sieving with standard conventional methods is quite expensive, bulky, time consuming and complex in operation. Additionally, powder sieving needs a separate area for placement which must be accommodated in the plant design. The agglomerated powder along with moist air and contaminants can choke the sieve mesh. This hampers further sieving operation. The sieve machines, after a while, have to be cleaned periodically either manually or by designing some automated method and this is an expensive and cumbersome process.

Moisture and other factors make the powder agglomerated and lumpy despite prior sieving as the powder is hygroscopic in nature and moisture can be picked up by the powder while lying in the powder container or while it is being transported from the recovery and sieving units back to the powder container for re-use. This agglomeration of the moist powder is a big source of an un-even powder coat, poor transfer efficiency, poor flow and poor finish.

Generally, sieve machines are integrated with the recovery units or placed under the recovery zone or placed separately outside the recovery unit. Further, powder collected in the recovery zones tends to get contaminated with impurities and other particles. Many a time it is this contaminated powder which is transported back to the master powder container with or without sieving either by pneumatic or mechanical means.

Further, in spite of the best sieving of the powder prior to transportation to the master spray container for further spraying, impurities can creep in during this process. Powder in the master spray container often still gets contaminated or even agglomerated due to various reasons such as absorption of moisture as it is continuously fluidized for long periods without being consumed especially since the powder is hygroscopic in nature. Another point of agglomeration is powder remaining stagnant within the powder container overnight for long periods of time. In such cases, even the prior sieved powder is subsequently coagulated and gets sprayed in the coagulated form.

Considering the above said problems, inventor of the present invention has invented and filed a patent application published as WO2015/193919 to sieve the powder in real time and air-wash powder sieving apparatus for powder coating system published as WO2019/069320. The system as disclosed in WO2015/193919 comprises a vibrating device configured for real time sieving of powder just before spraying. However, the system as disclosed is prone to periodic maintenance due to the presence of vibrating parts. To solve this problem, the inventor of this application filed the patent application claiming an air-wash powder sieving apparatus, however, the inventor observed that the said apparatus is also prone to periodic maintenance due to choking of the sieve when recovered and recycled powder having excessive contaminants and moisture in the powder is used. Further, the flow of powder and air in the system as disclosed in WO2019/069320 becomes irregular over the period of time.

Now a day, multiple coating guns are used in a powder coating system for large volume productions wherein one powder hopper is used for holding the powder in fluidized state. The coating operation may be manual or automatic. As shown in FIG. 1B, for using multiple guns (not shown), presently each gun has separate suction pipe (73) dipped in the powder container (78), and a suction pump for each suction pipe (73). A separate suction air connection (72) and a carrier air connection (74) connected to the suction air pump mounted on the suction pipe. Therefore, each coating gun requires its own individual control panel (76) to control the powder flow. The amount of suction air used and the secondary or carrier air used is controlled individually by means of air regulators (not shown). These air regulators are mounted in the control panel (76) which normally houses other electronic and electrical components too. This increases the cost and complexity of the system.

Therefore, according to inventor of this application, there is still a need of a means for sieving the powder in real time before spraying the powder, that will solve one or more of problems as discussed above and allow for continuous spraying over long periods.

### SUMMARY OF THE INVENTION

Accordingly, in one aspect the present invention provides a powder sieving apparatus for a powder coating system having at least one powder spray gun, a powder suction pump assembly, a control panel, and a powder container/hopper, the said sieving apparatus comprising a housing, a cylindrical sieve, and a brush holder.

According to an embodiment of the invention, the housing has at least one outlet connected to a suction side of the powder suction pump and an inlet connected to a suction pipe dipped in the powder container;

According to the present invention, the cylindrical sieve is adapted within the housing in such a way that divides the housing into two compartments, namely inner compartment, and outer compartment. The inner compartment is connected to the inlet of the housing and outer compartment is connected to the outlet of the housing The said cylindrical sieve comprises a sieve mesh through which powder is sucked by the powder suction pump from inner compartment to the outer compartment of the housing.

According to the present invention, the brush holder may be adapted rotatably and/or oscillatingly in the cylindrical sieve. According to the present invention, the said brush holder may comprise a plurality of bristles or wipers for scrubbing inner surface of the sieve mesh to keep the sieve mesh unclogged and clean.

According to an embodiment of the present invention, the cylindrical sieve may be held fixedly or rotatably within the housing.

According to another embodiment of the present invention, the brush holder may be hollow and may comprise a plurality of nozzles for spraying pressurised air over the surface of sieve mesh for skimming and washing the sieve mesh along with the bristles or wipers of the brush holder to prevent clogging and to ensure continuous flow of freshly sieved smooth flowing powder through the powder coating system.

According to the present invention, the powder sieving apparatus may be adapted in the powder coating system in such a way that non-sieved particles of powder/dust which have been cleaned and dislodged from the sieve by the brush and washing air, falls back into the powder container.

According to another embodiment of the present invention, the brush holder may comprise a plurality of rows of bristles or wipers and a plurality of rows of the nozzles or holes provided between the rows of the bristles or wipers, so the scrubbing and air wash happens simultaneously. In another embodiment, the brush holder may include a plurality of rows of the bristles or wipers and the nozzles or holes are provided between the bristles or wipers, so the scrubbing and air wash happens simultaneously. In another aspect the present invention provides a powder suction system comprising: a powder sieving apparatus of the present invention having a plurality of outlets and a single inlet connected to a suction pipe dipped in the powder container and a suction pump mounted removably or fixedly on each outlet of the powder sieving apparatus.

### BRIEF DESCRIPTION OF THE DRAWINGS

The above and other aspects, features, and advantages of certain exemplary embodiments of the present invention will be more apparent from the following description taken in conjunction with the accompanying drawings in which:

FIG. 1A shows a conventional/prior powder suction pump assembly;

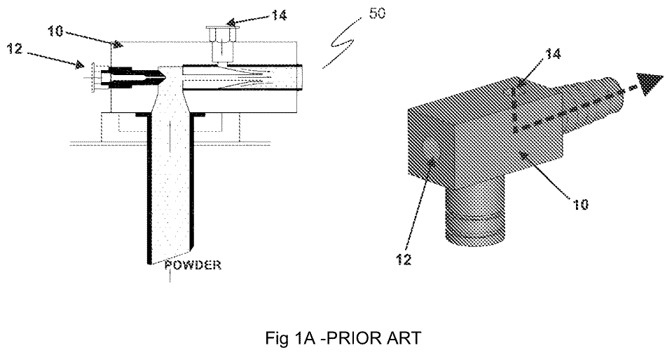

FIG. 1B shows a conventional/prior powder coating system;

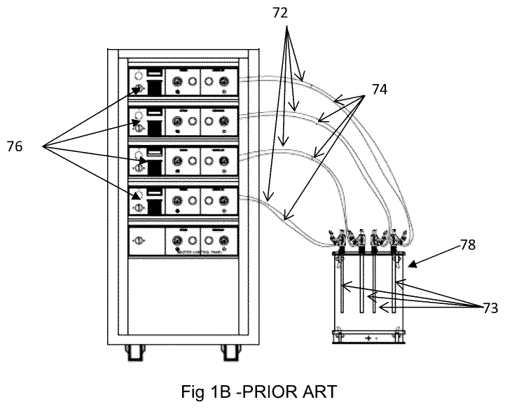

FIG. 2 shows an assembled view of a powder sieving apparatus in accordance with an embodiment of the invention;

FIG. 3. shows an exploded view of components of the powder sieving apparatus as shown in FIG. 2;

FIG. 4 shows flow of air and powder through the powder sieving apparatus in accordance with the invention;

FIG. 5 shows a powder coating system incorporating the powder sieving apparatus in accordance with an embodiment of the invention; and

FIG. 6 shows a powder sieving apparatus according to an embodiment of the present invention having multiple outlets; and

FIG. 7 shows a powder coating system having a powder sieving apparatus of the present invention shown in FIG. 6.

### DETAIL DESCRIPTION OF THE INVENTION

In general, the present invention provides a powder sieving apparatus for a powder coating system having a powder spray gun, a powder suction pump assembly, and a powder container/hopper. As per the present invention, the said sieving apparatus comprises a housing having at least one outlet connected to a suction side of the powder suction pump and an inlet connected to a suction pipe dipped in the powder container, a cylindrical sieve having a sieve mesh adapted within the housing dividing the housing into an inner and outer compartments, a brush holder rotatably and/or oscillatingly adapted in the inner compartment of the housing for cleaning the cylindrical sieve.

According to the present invention, the inner compartment of the housing formed by cylindrical sieve is connected to the inlet of the housing and the outer compartment of the housing connected to the outlet of the housing. The powder pump is connected to the outlet of the housing and the powder movement from the container takes place due to suction by the powder suction pump from the container to the inner compartment and out the outer compartment through the sieve mesh of the cylindrical sieve. According to an embodiment of the present invention, the cylindrical sieve may hold fixedly within the housing. According to another embodiment of the present invention, the cylindrical sieve may be adapted rotatably within the housing at a differential speed with the rotating brush holder.

According to the present invention, the said brush holder may have a plurality of bristles for scrubbing the inner surface of the sieve mesh to keep the sieve mesh unclog and clean. According to one another embodiment of the present invention, the brush holder may comprise a plurality of wipers instead of bristles wherein wipers are made of a different soft materials for scrub cleaning the inner surface of the mesh.

According to an embodiment of the present invention the brush holder includes at least one row of plurality of bristles for scrubbing the inner surface of the mesh.

According to another embodiment of the present invention, the brush holder may be hollow and may comprises plurality of nozzles/holes to permit pressurised air to flow over the sieve mesh surface to clean and keep the sieve mesh unclog as well as to provide the secondary or carrier air for transporting powder out smoothly through the gun.

According to an embodiment, the brush holder may include a plurality of rows of the bristles or wipers and a plurality of rows of the nozzles or holes provided between the rows of the bristles or wipers.

According to another embodiment, the brush holder may include a plurality of rows of the bristles or wipers and the nozzles or holes are provided between the bristles or wipers so the scrubbing and air wash action takes place almost simultaneously.

According to the present invention, the powder sieving apparatus can be adapted vertically or angularly for allowing the non-sieved material to fall back in the container. Preferably, the powder sieving apparatus may be adapted at an angle greater than 42 degrees with the horizontal axis for creating a slide for the non-sieved powder, and stray contaminants.

According to an embodiment of the present invention, the said apparatus may be connected removably to the suction side of the powder suction pump. As per another embodiment, the said apparatus may be integrated with the powder suction pump.

According to an embodiment of the invention, a powder suction pump(s) can be manufactured with an inbuilt powder sieving apparatus of the present invention by combining housing of the powder sieving apparatus with the body of the powder suction pump(s) to form a single integrated unit.

According to the present invention, the compressed air sprayed onto the sieve mesh along with scrubbing by the brush keeps sieve mesh de-clogged and also acts as secondary air that aids the smooth movement of the powder through the de-clogged sieve mesh, powder suction pump and hose and thus ensures that the powder is uniformly emitted out of the spray gun. Thus, this compressed air itself acts as the secondary air thereby eliminates the need for a separate compressed air inlet for the secondary air of the powder suction pump assembly, whilst keeping the sieve de-choked for smooth flow of powder continuously over long periods. The powder sieving apparatus cleans the sieve mesh physically and continuously with the brush along with carrier air, thereby the powder sieving apparatus of the present invention ensures continuous, smooth, and even flow of powder from even coagulated and impurity laden powder over long periods. There may be no need to stop work and clean the sieve or the apparatus during the working shift.

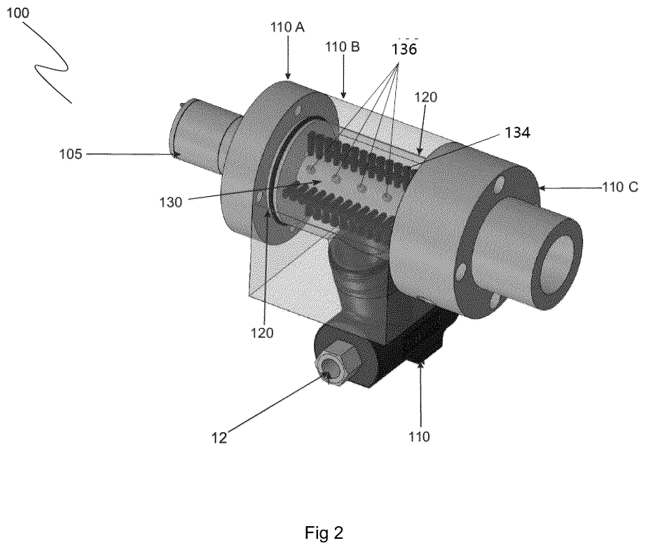

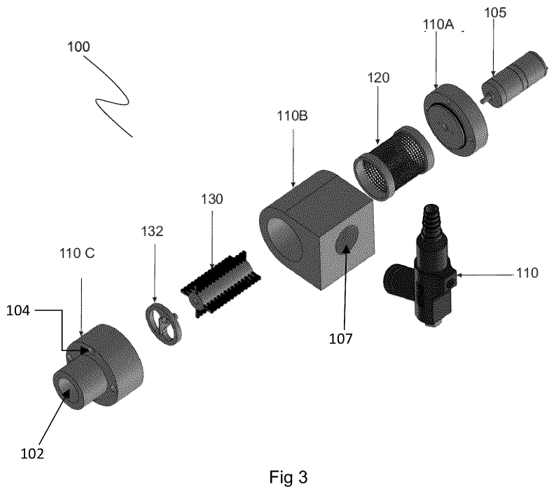

Referring FIG. 2 shows a powder sieving apparatus (100) for a powder coating system according to the preferred embodiment of the present invention and FIG. 3 shows an exploded view of the preferred embodiment of the powder sieving apparatus (100) shown in FIG. 2.

As shown in FIGS. 2 and 3, the powder sieving apparatus (100) comprises a housing (110A, 110B, 110 C), a cylindrical sieve (120) and a brush holder (130).

As shown in FIG. 3, the housing includes a top body (110A), a main body (110B), and bottom body (110C). The main body has one outlet (107), which acts as an outlet for powder and air and is connected to the powder suction pump (110) The bottom body (110C) of the housing has an inlet (102) for powder connected to the suction pipe thereby the powder sieving apparatus (100) establish connection between the powder pump and the suction pipe. The bottom body (110C) has one or more air inlets (104) for the secondary/carrier air to enter the brush holder (130) through the guide bush (132).

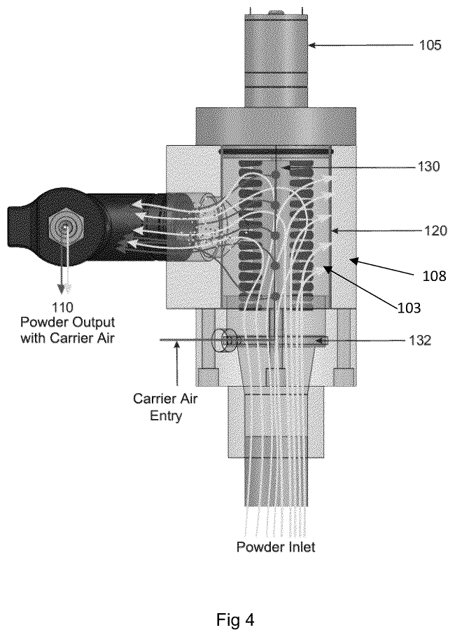

As shown in FIGS. 3 and 4, the cylindrical sieve (120) has a sieve mesh of a predetermined mesh size and a person skilled in the art can easily determine or select the mesh size of the sieve mesh based on the coating to be given on the subject. The cylindrical sieve (120) is adapted within the main body which divides the main body of the housing into two compartments namely inner compartment (103) and outer compartment (108). The inner compartment (103) is connected to the inlet (102) of the housing and the outer compartment (108) is connected to the outlet (107) of the housing. According to the present invention, the cylindrical sieve may be held fixedly or rotatably within the housing. When the cylindrical sieve is held rotatably within the housing, the cylindrical sieve is configured to rotate either at a differential speed in the rotational direction of the brush holder or in the opposite direction of the brush holder. A person skilled in the art can easily understand and make out the gear mechanism required to rotate the cylindrical sieve at the differential speed in the rotational direction of the brush holder or in the opposite direction of the brush holder, hence no need to explain in detail.

The brush holder (130) as shown in FIGS. 2-5 is adapted rotatably with the help of guiding bush (132) in the cylindrical sieve (120). The brush holder (130) as shown in FIGS. 2 and 3 comprises four rows of plurality of bristles (134) for scrubbing inner surface of the sieve mesh and four rows of nozzles or holes (136) for spraying pressurised carrier air over the surface of sieve mesh to keep the sieve mesh unclog and clean. Alternatively, the brush holder can be adapted moving up-down to clean the cylindrical sieve. Alternatively, brush holder may comprise a plurality of wipers for scrubbing inner surface of the sieve mesh.

As shown in FIGS. 2-5, the brush holder is rotated with the help of motor (105) adapted on the top body of the housing. Generally, the rotating speed of the brush holder is between 35 and 60 RPM depending on the application. It may be kept higher depending on stickiness and type of powders like powders with aluminum particles used to produce metallic finishes.

As shown in FIG. 4, the carrier air is guided through the guide bush (132) into the brush holder for spraying over the sieve mesh though the nozzles (136).

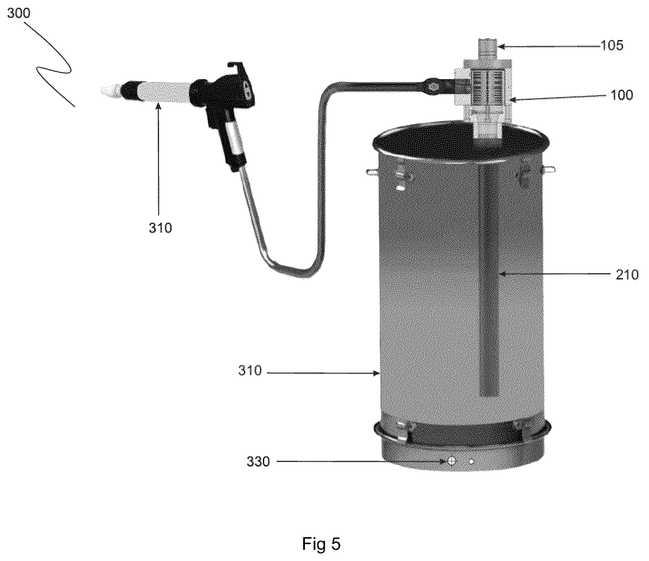

FIG. 5 shows that a powder coating system (300) comprising a powder suction pump integrated with the powder sieving apparatus (100) and the suction pipe (210) according to the present invention connected between a powder spray gun (310) and a powder container (310). According to the present invention, the powder suction pump may be integrated fixedly or removably.

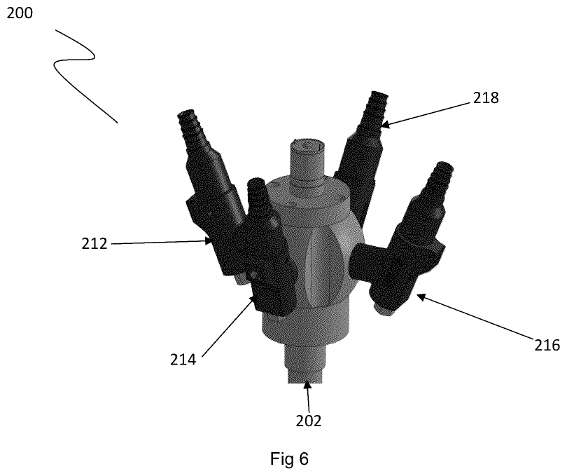

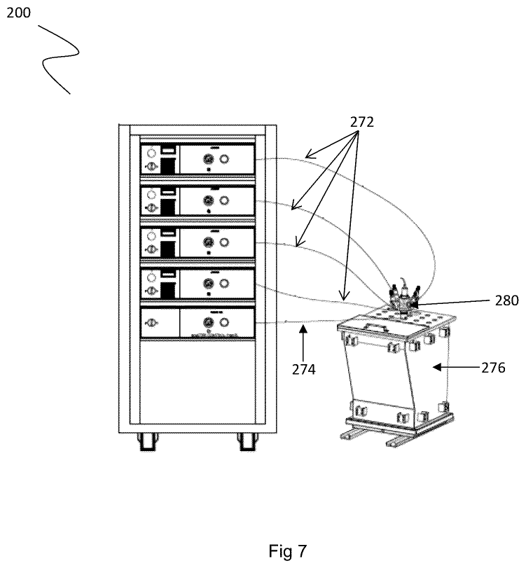

According to further embodiment of the present invention, the housing of the powder sieving apparatus may have a single inlet for powder and a plurality of outlets for connecting with the plurality of the suction pumps. Referring FIG. 6 shows another embodiment of the present invention wherein a powder sieving apparatus (200) has one inlet (202) for connecting to a suction pipe dipped in the powder container and four outlets at a predetermined positions connected to the four suction pumps (212, 214, 216, 218) allowing to connect with four powder spray guns. Referring FIG. 7 shows the powder sieving apparatus (280) adapted in an automatic powder coating system (200). As shown in FIG. 7, the powder coating system (200) comprises the powder sieving apparatus having one suction pipe dipped in the powder container (276) and four suction air lines (272) are connected to four suction air pumps adapted to the four outlets of the powder sieving apparatus (276). The carrier air (274) is connected to the powder sieving apparatus (290) of the present invention which acts as a secondary air for each outlet along with skimming and washing the sieve mesh. Hence there is no need for a secondary or carrier air controller as a common air controller can supply sufficient secondary or carrier air to the nozzles on the brush holder. This saves on the use of multiple secondary or carrier air controllers. In a method of operation FIG. 4 shows flow of powder and air through the sieving apparatus of the present invention. The powder to be coated is kept in fluidized state in the container by compressed air through an air inlet (330) under a porous plate on which the powder rests. The powder is sucked through the suction pipe (210) with the help of the powder suction pump and passes though the sieving apparatus (100) of the present invention. The powder sucked by a suction force created by the primary air of the powder suction pump, is forced through the cylindrical sieve of the sieving apparatus. The brush holder rotates by the motor continuously to scrub the inner surface of the mesh sieve and the nozzles provided on the brush holder sprays the carrier air onto the sieve mesh thereby keeping the sieve mesh clean and de-clogged. Further, while it is known that the carrier air can be simply introduced in the powder path, however in the present invention as this carrier air is injected through the nozzles on the rotating brush holder, it helps to clean and de-clog the sieve mesh and also after cleaning the sieve mesh, aids in a smooth powder movement through powder hose and powder spray gun creating uniform even flow of the powder and air.

In all cases the powder filtered through the powder sieving apparatus of the present invention is free flowing powder which will be charged by the powder spray gun for coating onto a workpiece and the powder lumps and contaminants which does not pass through the sieve mesh falls back into the powder container.

The present sieving apparatus provides freshly sieved powder free of large impurities and the powder particles which are distinctly separated and presented to the charging device such as a powder spray gun and the particles are thus charged better resulting in substantially and better transfer efficiency and this results in lower powder consumption, and this is easily demonstrated during operation. The smaller mass of the individual powder particles versus the lumped powder particles makes them more tenable to easily accept an electrostatic charge. The distinctly separated powder particles of the sieved powder ensure a superior powder cloud emitted out of a spray gun and a more even and smooth powder flow with better uniformity and improved deposition efficiency. The present scrub clean and air-wash powder sieving apparatus is a non-vibrating sieving apparatus which eliminates wear and tear of the apparatus and ensures minimal maintenance with continuous flow in real time.

The sieving apparatus including parts such as housing, brush holder, guide bush and the like can be preferably made of plastic or metal. The carrier air can be of a different pressure or different air volume and numerous modifications and adaptations may be made thereto without departing from the spirit and scope of invention. The sieving apparatus of the present invention can be easily adapted to the presently available powder coating systems. Further, a powder suction pump or suction pipe can be manufactured with inbuilt powder sieving apparatus of the present invention by combining housing of the scrub clean and air-wash powder sieving apparatus with the body of the powder suction pump or body of suction pipe without departing from the spirit and scope of invention. Figures are merely representational and are not drawn to scale. Certain portions thereof may be exaggerated, while others may be minimized. Figures illustrate various embodiments of the invention that can be understood and appropriately carried out by those of ordinary skill in the art.

In the foregoing detailed description of embodiments of the invention, various features are grouped together in a single embodiment for the purpose of streamlining the disclosure.

It is understood that the above description is intended to be illustrative, and not restrictive. It is intended to cover all alternatives, modifications and equivalents as may be included within the spirit and scope of the invention as defined in the appended claims.

I claim:

1. A powder sieving apparatus for a powder coating system having a powder spray gun, a powder suction pump assembly, and a powder container/hopper, the said sieving apparatus comprising:
a housing having at least one outlet connected to a suction side of the powder suction pump and an inlet connected to a suction pipe dipped in the powder container;
a cylindrical sieve within the housing dividing the housing into two compartments, an inner compartment connected to the inlet of the housing and outer compartment connected to the outlet of the housing, said cylindrical sieve having a sieve mesh through which powder is sucked by the powder suction pump from inner compartment to the outer compartment; and
a brush holder rotatably and/or oscillatingly adapted in the cylindrical sieve, said brush holder has a plurality of bristles or wipers for scrubbing inner surface of the sieve mesh to keep the sieve mesh unclogged and clean.

2. The powder sieving apparatus as claimed in claim 1, wherein the cylindrical sieve is held fixedly or rotatably within the housing.

3. The powder sieving apparatus as claimed in claim 2, wherein the cylindrical sieve is configured to rotate at differential speed in the rotational direction or opposite direction of the brush holder.

4. The powder sieving apparatus as claimed in claim 1, wherein the brush holder is hollow and comprises a plurality of nozzles or holes for spraying pressurised air over the surface of sieve mesh for skimming and washing the sieve mesh along with the bristles or wipers of the brush holder to prevent clogging and to ensure continuous flow of freshly sieved smooth flowing powder through the powder coating system.

5. The powder sieving apparatus as claimed in claim 4, wherein the brush holder comprises the plurality of rows of plurality of bristles or wipers and a plurality of rows of the nozzles or holes provided between the rows of the bristles or wipers, so the scrubbing and air wash takes place simultaneously.

6. The powder sieving apparatus as claimed in claim 4, wherein the brush holder includes the plurality of rows of the bristles or wipers, and the nozzles or holes are provided between the bristles or wipers, so the scrubbing and air wash takes place simultaneously.

7. The powder sieving apparatus as claimed in claim 1, wherein the brush holder is rotated and/or oscillated by a motor.

8. The powder sieving apparatus as claimed claim 1, wherein the apparatus is adapted vertically or angularly on the powder coating system for allowing falls back of non-sieved powder in the container.

9. The powder sieving apparatus as claimed in claim 8, wherein the apparatus is adapted at an angle preferably above 42 degrees.

10. The powder sieving apparatus as claimed in claim 1 wherein the housing comprises a plurality of outlets for adapting suction pump on each outlet.

11. The powder sieving apparatus as claimed in claim 1, wherein the said apparatus is connected removably to the suction side of the powder suction pump.

12. The powder sieving apparatus as claimed in claim 1, wherein the said apparatus is integrated with the powder suction pump or inbuilt in a powder suction pump(s) by combining housing of the powder sieving apparatus with the body of the powder suction pump(s) to form a single integrated unit.

13. A powder suction system comprising:
a powder sieving apparatus as claimed in claim 1, said powder sieving apparatus having a plurality of outlets and a single inlet connected to a suction pipe dipped in the powder container; and
a suction pump mounted removably or fixedly on each outlet of the powder sieving apparatus.
